(19) United States
(12) Patent Application Publication
(10) Pub. No.: US 2008/0155492 A1
(43) Pub. Date: Jun. 26, 2008

(54) DEVELOPMENT TOOL FOR CREATING CONVERGED APPLICATIONS THAT INCLUDE SIP AND WEB COMPONENTS

(75) Inventors: DELROY W. COLE, BOYNTON BEACH, FL (US); DWAYNE DAMES, BOYNTON BEACH, FL (US); GIRISH DHANAKSHIRUR, DELRAY BEACH, FL (US); ROCCO F. PALERMO, BOYNTON BEACH, FL (US); AIMEE SILVA, MIRAMAR, FL (US); LENORA E. WRIGHT, WEST PALM BEACH, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/615,555

(22) Filed: Dec. 22, 2006

(51) Int. Cl. G06F 9/44

(52) U.S. Cl. 717/100

(57) ABSTRACT

A software development environment including a set of SIP tools and a set of Web tools. The SIP tools are configured to create software able to execute upon a SIP server. The Web tools are configured to create software able to execute upon a Web server. The software development environment can also include a common development interface configured to develop converged projects including objects created with the SIP tools and the Web tools able to execute upon an Application Server which supports Converged SIP/HTTP applications. The common development interface can be a graphical development interface including a development canvas and a palette including elements which are able to be added to the canvas. The elements can include at least one SIP element corresponding to one of the SIP tools and at least one Web element corresponding to one of the Web tools.

### BACKGROUND

1. Field of the Invention

The present invention relates to the field of software development and, more particularly, to a development tool for creating converged applications that include SIP and Web components.

2. Description of the Related Art

An increasing demand exists for integrated enterprise applications that provide both a Web-based interface and a telephony interface to backend management information systems (MIS). Sometimes, these integrated applications are designed so that the Web and telephony interfaces are mutually exclusive of each other. That is, a user can access the backend enterprise system using either a telephone client interface, such as a voice response system, that is connected to a telephony server that in turn connects to the enterprise backend. A user can also use a Web client connected to a Web server that, in turn, connects to the enterprise backend. The sharing of common components in a mutually exclusive interface implementation is done to reduce maintenance and development overhead, to ensure consistency of user handling regardless of interface used, and to promote a unified upgradeability of common components to future-proof the integrated system.

Another type of integrated application can be referred to as converged application, wherein during a single interactive session with a user, both a telephony interface (linked to a telephony server) and a Web interface (lined to a Web server) are utilized. The interfaces of a converged application need not, but may connect to a common enterprise backend. One example of a converged application can be a “soft” Voice Over Internet Protocol (VOIP) phone that is initialized from a Web interface. In another example, the converged application can be an interface that permits users to interact with an automated response system and/or a live agent through different switchable modalities, such as a chat or an instant messaging interface (i.e., a text exchange modality) and a telephone interface (i.e., a speed modality).

A few conventional application servers, such as WebSphere Application Server V6.1 by International Business Machines Corporation (IBM) of Armonk, N.Y., provide a capability of running a converged (or integrated) application in a common converged container, which is accessible by telephony (i.e. via Session Initation Protocol—SIP) and Web server components. At present, however, coherent tooling for developers is nonexistent. Existing solutions involve using one software development tool to develop a telephone application (for executing in a telephone server) and a different software development tool to develop a Web-based application (for executing in a Web server). Remote Method Invocation (RMI) sockets are typically used to communicate between these two distinct applications. The lack of coherent tooling has resulted in an inconsistency in converged applications, added expense due to increased integration and maintenance times, and other related problems

### SUMMARY OF THE INVENTION

The present invention discloses a software development tooling solution that permits developers to use a single interface to construct converged applications having components (or services) executing in a Web server and components executing in a telephony server. The solution permits developers to configure the converged components/services as well as a converged component/service. For example, the solution can be part of an integrated development environment (IDE) that provides toolbars to palettes including Session Initiation Protocol (SIP) based elements, and Hyper/Text Transfer Protocol (HTTP) or Web-based elements, each of which can be dropped into a common canvas, where they can be graphically manipulated. Selecting a component in the canvas causes development options specific to that component type to be displayed, which a developer can manipulate. A converged component/service can be defined, through which SIP and Web components can share state and other information. Deployment descriptors needed for such converged applications/servers can be developed with the solution and can contain deployment descriptors for both the SIP and Web parts of the converged application.

The present invention can be implemented in accordance with numerous aspects consistent with material presented herein. For example, one aspect of the present invention can include a software development environment including a set of SIP tools and a set of Web tools. The SIP tools are configured to create software able to execute upon an SIP server. The Web tools are configured to create software able to execute upon a Web server. The software development environment can also include a common development interface configured to develop converged projects including objects created with the SIP tools and the Web tools. The common development interface can be a graphical development interface including a development canvas and a palette including elements which are able to be added to the canvas. The element can include at least one SIP element corresponding to one of the SIP tools and at least one Web element corresponding to one of the Web tools.

Another aspect of the present invention can include a converged software application that includes a SIP server object, a Web server object, and an application server object. The SIP server object can be configured to execute in a SIP server. The Web server object can be configured to exercise in a Web server. The application session object can be an object through which the SIP object and the Web object share state information. Each of the SIP server, Web server, and application session objects can be developed using a single converged application development tool.

Still another aspect of the present invention can include a software development method for converged applications. The method can include a step of initiating a converged project using a graphical development tool. A Web object can be added to the converged project using the graphical development tool, wherein the Web object can be configured to be deployed in a Web server. A SIP object can also be added to the converged project using the graphical development tool, wherein the SIP object can be configured to be deployed in a SIP server. The Web object and the SIP objects can be linked using the graphical development tool so that state information can be shared between the Web object and the SIP object and the resulting application can be deployed on an Application Server which supports converged SIP and Web applications.

It should be noted that various aspects of the invention can be implemented in a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiment which are presently preferred, it being understood, however, that the invention is not limited to the precise arrangements and instrumentalities shown.

FIG. 1 is a schematic diagram illustrating an integrated development tooling system to create converged applications containing Web and SIP components in accordance with embodiments of the inventive arrangements disclosed herein.

FIG. 2 is a graphical user interface (GUI) illustrating a software development tool for the creation of converged applications containing SIP and Web components in accordance with an embodiment of the inventive arrangements disclosed herein.

FIG. 3 is a flow chart of a method for creating a converged application in accordance with an embodiment of the inventive arrangements disclosed herein.

### DETAILED DESCRIPTION OF THE INVENTION

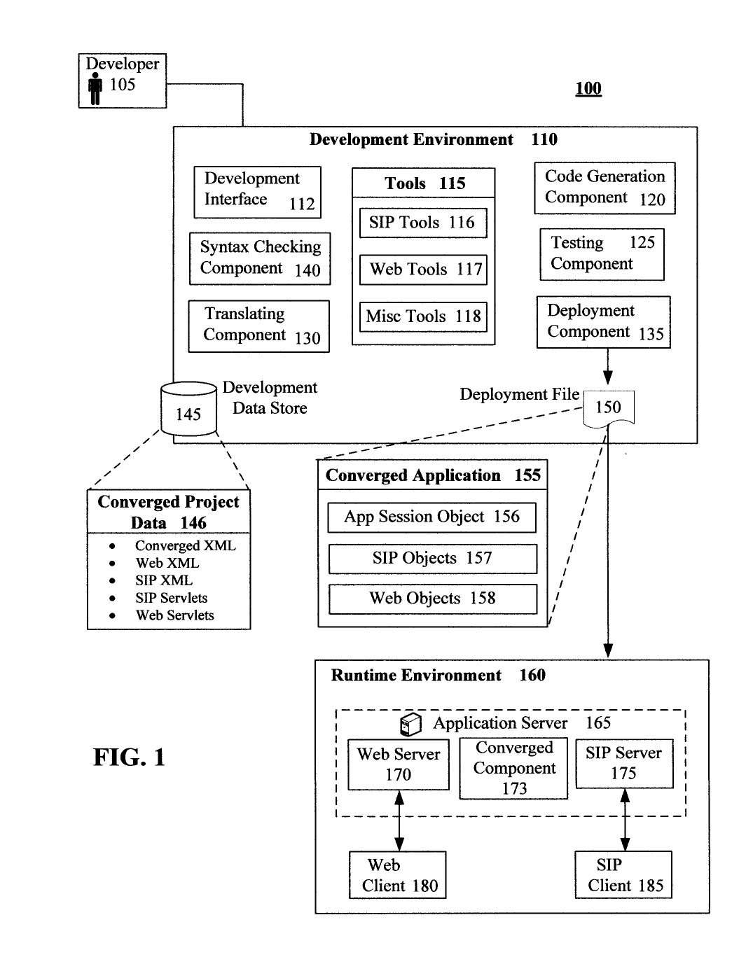

FIG. 1 is a schematic diagram illustrating an integrated development tooling system 100 to create converged applications containing Web and SIP components in accordance with embodiments of the inventive arrangements disclosed herein. In system 100, a developer 105 can use the development environment 110 to create and deploy a converged application 155. The development environment 110 can include a development interface 112, tools 115, a development data store 145, and a variety of software development components 120-140. The development environment 110 can be a standalone environment or part of an integrated development environment (IDE).

The development interface 112 can represent the means by which a developer 105 can manipulate the elements of the application being developed and create the code necessary to support application behavior. To create the converged application 155, the development interface 112 can access the functionality provided by the various tools 115 and components 120-140. The development interface 112 can include graphical user interfaces (GUIs) as well as command line elements.

Since the purpose of the development environment 110 is to create a converged application 155, the developer 105 can utilize a multitude of applicable tools 115. The SIP tools 116 can allow the developer 105 to add and configure SIP objects for use in the application 155. Likewise, the Web tools 117 can allow the developer 105 to add and configure Web objects for use in the application 155. The miscellaneous tools 118 can provide options for additional elements not related to SIP and Web functions.

The development environment 110 can also include a variety of software development components, such as a code generation component 120, a testing component 125, a translation component 130, a deployment component 135, and a syntax checking component 140. Although such components are often included in various commercially available development environments, it should be noted that these components 120-140 can apply their functionality to handle the creation and production of a converged application 155, unlike those currently available. For example, the testing component 125 can test the underlying code for both SIP and Web objects within a single application project.

During development, the development interface 112, tools 115, and components 120-140 can access the contents of the development data store 145. The development data store 145 can contain the converged project data 146. It should be noted that a software application and its supporting files and data is called a project while being developed, once the project is deployed, then it is typically referred to as an application. As shown in this example, the converged project data 146 can include the converged XML, Web XML, SIP XML, SIP servlets, and Web servlets and other resources.

Once development activities are completed, the developer 105 can use the deployment component 135 to create a deployment file 150. This deployment file 150 can include the completed converged application 155. The converged application 155 can include an application session object 156, SIP objects 157, and Web objects 158. SIP objects and Web server objects share state information through the application session object 156. These objects 156, 157, and 158 can be embedded within the code of the deployment file 150 for use in the runtime environment 160.

The runtime environment 160 can include an application server 165 to run a converged application 155 and clients 180 and 185 to create the converged application 155. The application server 165 can include a web server 170, converged component 173, and SIP server 175. The converged component 173 can execute a converged object contained within the deployment file 150. The Web server 170 can supply a Web client 180 with the functionality of Web objects 158 contained within the deployment file 150. Likewise, the SIP server 175 can support the SIP objects 157 contained within the deployment file 150 to the SIP client 185.

The runtime environment 160 can be a JAVA 2 PLATFORM ENTERPRISE EDITION (J2EE) software environment. Accordingly, the application server 165 can be a J2EE compliant application server, such as a WebSphere Application Server V6.1 from International Business Machines Corporation (IBM), of Armonk, N.Y., a BEA WEBLOGIC application server from BEA Systems, Inc. of San Jose, Calif., a JBOSS application server from JBoss, Inc. of Atlanta, Ga., a JOnAS application server from the ObjectWeb Consortium, and the like. The runtime environment 160 is not to be construed as limited in this regard and other software platforms, such as the .NET software platform, are contemplated herein.

As used herein, presented data stores, including store 145 can be a physical or virtual storage space configured to store digital information. Data store 145 can be physically implemented within any type of hardware including, but not limited to, a magnetic disk, an optical disk, a semiconductor memory, a digitally encoded plastic memory, a holographic memory, or any other recording medium. Each of the data store 145 can be a stand-alone storage unit as well as a storage unit formed form a plurality of physical devices. Additionally, information can be stored within data store 145 in a variety of manners. For example, information can be stored within a database structure or can be stored within one or more files of a file storage system, where each file may or may not be indexed for information searching purposes. Further, data store 145 can utilize one or more encryption mechanisms to protect stored information from unauthorized access.

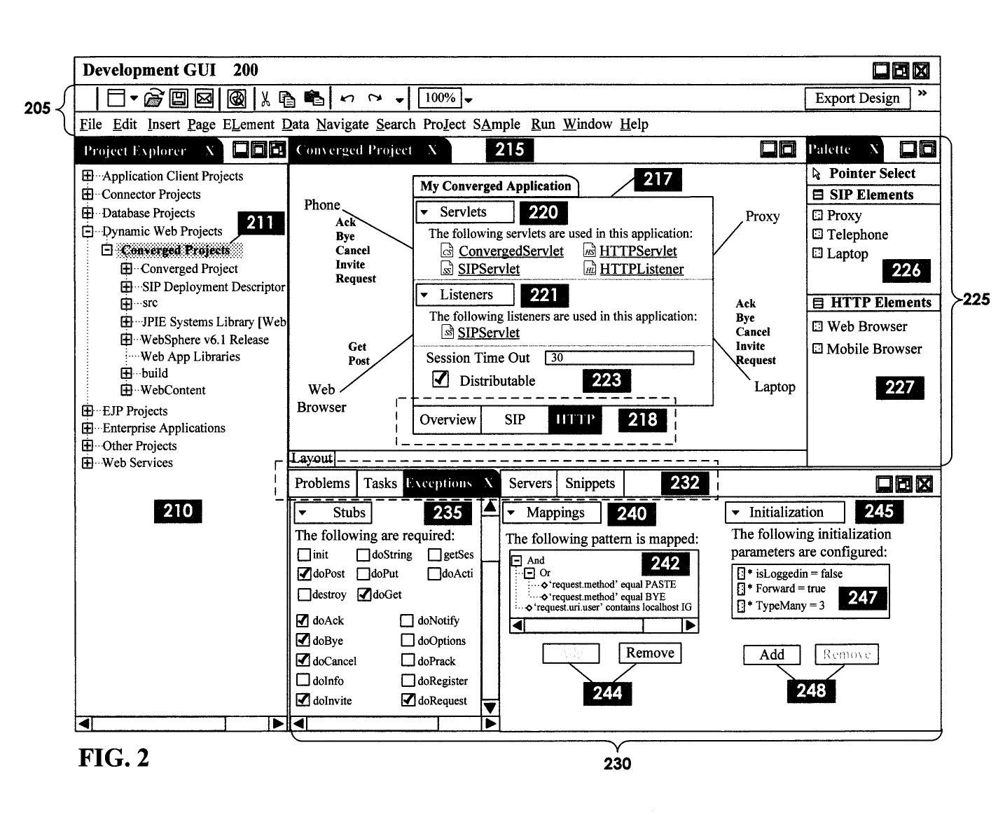

FIG. 2 is a graphical user interface (GUI) 200 illustrating a software development tool for the creation of converged applications containing SIP and Web components in accordance with an embodiment of the inventive arrangements disclosed herein. This development GUI 200 can be used within the context of system 100 or any other software development environment supporting the creation of converged applications.

Like many conventional software development interfaces, the development GUI 200 can include toolbars 205 and functional areas 210, 215, 225, and 230 in which to perform development tasks. It should be noted however, that the functionality of these functional areas 210, 215, 225, and 230 is enhanced beyond that of current development tools, specialized for the inclusion and configuration of both SIP and Web objects to a single application.

As such, the toolbars 205 can include additional menu items (not shown) to account for operations for both SIP and Web objects. Likewise, the functional areas 210, 215, 225, and 230 can also appear similar to conventional development tools with additional capabilities that are specific to SIP and Web objects of a converged application. It should be noted that the contents of the functional areas 210, 215, 225, and 230 are meant for illustrative purposes only and are not meant to exactly or extensively define or limit the functionality of the invention.

The project explorer are 210 can display a variety of data associated with various development projects accessible by the development GUI 200. This data can be displayed in a hierarchical tree structure, as shown in this example, and can be stored in a data store, such as the development data store 145 of system 100. A developer can use this explorer area 210 to create, and/or manage data pertaining to convergent projects 211.

A converged project area 215 can display the layout of various SIP and Web objects and/or object parameters associated with a converged application and allow a developer to modify the objects and/or object parameters associated with the converged application. In this example, a developer can use the tabs 218 to view and/or modify the objects, and/or parameters associated with a specific converged application in a converged application interface 217. As shown in this example interface 217, a developer can modify the servlet 220 and listener 221 objects and/or the time out 223 parameter for the Web objects associated with the converged application.

Within the palette area 225, a developer can add, select, and/or modify the specific SIP elements 226 and/or Web elements 227 of the converged application. The coding area 230 can include a variety of elements and functions for the generation of the software code associated with the converged application. This area 230 can include tabs 232 that pertain to specific coding functions, like those shown in this example.

When a developer selects one of the tabs 232, associated interfaces can be displayed. In this example, the exceptions tab is selected, noted by a different colored tab, displaying a stubs sub-area 235, mapping sub-area 240, and an initialization sub-area 245. These sub-areas 235, 240, and 245 can provide a graphical means for the developer to automatically generate associated code pieces for the converged application. For example, the selection of items within the stubs sub-area 235 can automatically generate code stubs for the selected items within the code file associated with the converged application.

The mapping sub-area 240 can include a pattern area 242 and function buttons 244. The function buttons 244 can allow the developer to modify the contents of the pattern area 242. In this example, a developer can add or remove the variables and/or their logical relationships.

The initialization sub-area 245 can include a parameter area 247 and function buttons 248. The function buttons 248 can allow the developer to modify the contents of the parameter area 247. The contents of the parameter area 247 can include the value designated as the initial value of specific session variables to be used by the converged application when started. In this example, a developer can add or remove the session variables and/or their specified values.

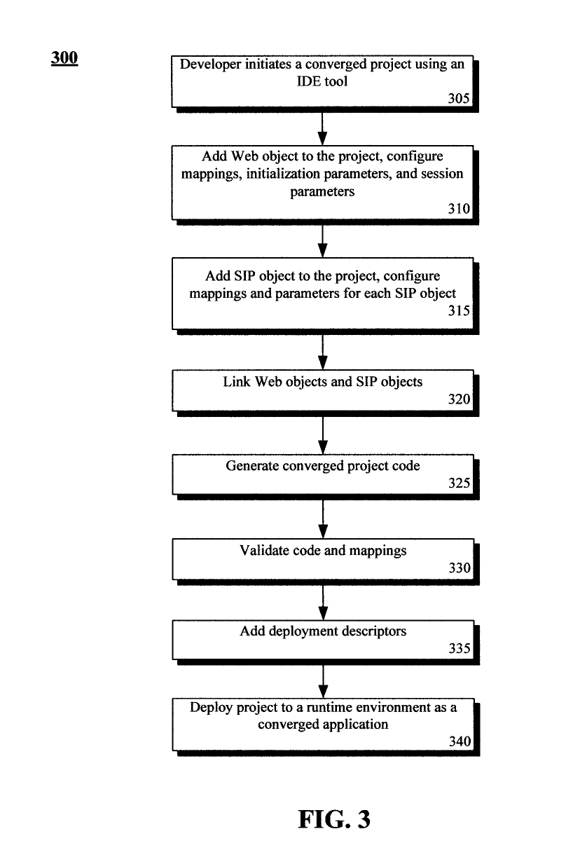

FIG. 3 is a flow chart of a method 300 for creating a converged application in accordance with an embodiment of the inventive arrangements disclosed herein. Method 300 can be performed in the context of system 100 and can utilize a development GUI 200 or can be performed in the context of any other system utilizing an integrated tool set for creating applications containing SIP and Web components.

Method 300 can begin when a developer initiates a converged project using an IDE tool in step 305. In step 310, the developer can add a Web object to the project and configure the object's mappings, initialization parameters, and session parameters. The developer can add a SIP object to the project and configure the object's mappings and parameters in step 315.

In step 320, the developer can link all the Web and SIP objects in the project. The developer can then use the tool to generate converged project code in step 325. In step 330, the code and mappings can be validated. Deployment descriptors can be added in step 335. In step 340, the project can be deployed to a runtime environment as a converged application.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which loaded in a computer system is able to carry out these methods. Computer program in the present context means any expression, in any language, code or notation, of a set of instructions intended to cause a system having an information processing capability to perform a particular function either directly or after either or both of the following: a) conversion to another language code or notation; b) reproduction in a different material form.

What is claimed is:

1. A software development environment comprising:
a set of Session Initiation Protocol (SIP) tools configured to create software able to execute upon a SIP server;
a set of Web tools configured to create software able to execute upon a Web servers; and
a common development interface configured to develop at least one of converged projects and converged applications including objects created with the SIP tools and the Web tools.

2. The software development environment of claim 1, wherein the common development interface is a graphical development interface including a development canvas and a palette including elements which are able to be added to the canvas, said elements including at least one SIP element corresponding to one of the SIP tools and at least one Web element corresponding to one of the Web tools.

3. The software development environment of claim 2, further comprising:
a property configuration window, wherein when a SIP element has focus in the development canvas, the property configuration window includes editable properties relating to the SIP element, and wherein when a Web element has focus in the development canvas, the property configuration window includes editable properties relating to the Web element.

4. The software development environment of claim 2, further comprising:
a stubs editing window presenting a plurality of editable customizations specific to an element in the development canvas that has focus, wherein different customizations are presented in the stubs editing window depending on an element type that has focus.

5. The software development environment of claim 2, further comprising:
a mapping window presenting a plurality of editable mappings specific to an element in the development canvas that has focus, wherein different mappings are presented in the mappings window depending on an element type that has focus.

6. The software development environment of claim 2, further comprising:
an initialization editing window presenting a plurality of editable initialization parameters specific to an element in the development canvas that has focus, wherein different initialization parameters are presented in the initialization editing window depending on an element type that has focus.

7. The software development environment of claim 2, further comprising:
an option to generate code in a converged project, wherein selection of the option creates code for objects created with the SIP tools and the Web tools.

8. The software development environment of claim 7, wherein selection of the option results in a creation of Session Initiation Protocol (SIP) servlet code and HyperText Transfer Protocol (HTTP) servlet code.

9. The software development environment of claim 2, wherein a converged project includes a SIP eXtensible Markup Language (.xml) file containing information for each SIP servlet in the converged project as well as mapping information and customization information, and wherein a converged project includes a Web.xml file containing information for each HTTP servlet in the converged project as well as map information and customization information.

10. The software development environment of claim 2, further comprising:
a deployment component for generating an archive file which is able to be deployed into an application server, said application server including a Web server component in which Web objects developed with the Web tools are deployed and a SIP server component within which SIP objects developed with the SIP tools deployed.

11. The software development environment of claim 1, further comprising:
a set of converged application tools configured to create an application session object through which SIP objects and Web server objects share state information.

12. The software development environment of claim 1, further comprising:
a deployment component for creating a converged application deployment file, said deployment file including deployment descriptions for a SIP server object created using the SIP tools and for a Web server object created using the Web tools.

13. A converged software application comprising:
a SIP server object configured to execute in a SIP server;
a Web server object configured to execute in a Web server; and
an application session object through which the SIP server object and the Web server object share state information, wherein the SIP server object, the Web server object, and the application session object are developed using a single converged application development tool.

14. The converged software application of claim 13, wherein the converged application development tool is a part of an integrated development environment including a graphical development interface that includes a development canvas and a palette including elements which are able to be added to the canvas, said elements including at least one SIP element used to create the SIP server object and at least one Web element used to create the Web server object.

15. The converged software application of claim 13, wherein the converged software application is configured to execute in an application server, said application server including a Web server component in which the Web server object executes and a SIP server component in which the SIP server object executes.

16. The converged software application of claim 13, in which the converged software application is deployed from a development file created by the converged application development tool, said deployment file including deployment descriptors for the SIP server object and for the Web server object.

17. A software development method comprising:
initiating a converged project using a graphical development tool;
adding a Web object to the converged project using the graphical development tool, wherein the Web object is configured to be deployed in a Web server;
adding a SIP object to the converged project using the graphical development tool, wherein the SIP object is configured to be deployed in a SIP server; and
linking the Web object and the SIP objects using the graphical development tool so that state information is shared between the Web object and the SIP object.

18. The method of claim 17, further comprising:
using the graphical development tool to configure mappings and parameters for the Web object and the SIP object.

19. The method of claim 17, further comprising:
adding deployment descriptors for the SIP object and the Web object using the graphical development tool.

20. The method of claim 17, further comprising:
creating a deployment file that includes the Web object and the SIP object;
deploying the development file into an application server that includes a Web server component in which the Web object executes and a SIP server component in which the SIP object executes.
